(19) United States
(12) Patent Application Publication
(10) Pub. No.: US 2013/0024569 A1
(43) Pub. Date: Jan. 24, 2013

(54) INFORMATION PROCESSING APPARATUS AND INFORMATION PROCESSING METHOD

(71) Applicants: Nobuyuki Iwauchi, Kawasaki-shi (JP); Ayako Hirose, Kawasaki-shi (JP)

(72) Inventors: Nobuyuki Iwauchi, Kawasaki-shi (JP); Ayako Hirose, Kawasaki-shi (JP)

(73) Assignee: CANON KABUSHIKI KAISHA, Tokyo (JP)

(21) Appl. No.: 13/523,333

(22) Filed: Jun. 14, 2012

(30) Foreign Application Priority Data
Jul. 22, 2011 (JP) 2011-161370

(51) Int. Cl. G06F 15/173

(52) U.S. Cl. 709/225

(57) ABSTRACT

An information processing apparatus and method capable of suitably controlling access by a client apparatus are provided. The information processing apparatus comprises: a receiving unit configured to receive an access request, which is a request by the client apparatus to access content, from the client apparatus together with an area identifier for the client apparatus; a decision unit configured to specify location of the client apparatus based upon the access request and to decide in accordance with the specified location whether the client apparatus is allowed to access the content; and a determination unit configured to specify the area corresponding to the client apparatus, based upon the area identifier, and to determine an access destination to which the client apparatus accesses based upon the access request in accordance with the specified area.

### BACKGROUND OF THE INVENTION

1. Field of the Invention

The present invention relates to an information processing apparatus and method for controlling access to content by a client apparatus.

2. Description of the Related Art

A technique for managing access by a client apparatus to content via a network has been proposed heretofore (for example, see Japanese Patent Laid-Open No. 2004-110480). In such systems, whether content is allowed to be viewed is determined by referring to a global IP address that has been assigned to the client apparatus. A global IP address is one allocated from an ISP (Internet Service Provider).

However, in order to determine the region in which a client apparatus performs access in a system in which reference is had to a global IP address, processing is executed without taking into consideration the region for which the client apparatus is destined. As a consequence, there are cases where content conforming to the wishes of the user cannot be provided appropriately.

### SUMMARY OF THE INVENTION

The present invention provides an information processing apparatus and method capable of appropriately controlling access by a client apparatus.

According to one aspect of the present invention, an information processing apparatus for controlling access by a client apparatus, comprises: a receiving unit configured to receive an access request, which is a request by the client apparatus to access content, from the client apparatus together with an area identifier for specifying an area that corresponds to the client apparatus; a decision unit configured to specify location of the client apparatus based upon the access request received from the receiving unit and to decide in accordance with the specified location whether the client apparatus is allowed to access the content; and a determination unit configured to specify the area corresponding to the client apparatus, based upon the area identifier received by the receiving unit, and to determine an access destination to which the client apparatus accesses based on the access request in a case where the decision unit decides to allow access by the client apparatus to the content, in accordance with the specified area.

In accordance with the present invention, access by a client apparatus can be controlled appropriately.

Further features of the present invention will become apparent from the following description of exemplary embodiments (with reference to the attached drawings).

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is an overall block diagram of a content distribution system according to a first embodiment of the present invention;

FIG. 2 is a block diagram of the interior of an image processing apparatus;

FIG. 3 is a functional block diagram of a relay apparatus;

FIG. 4 is an operation flowchart of processing executed by a relay apparatus; and

FIG. 5 is a diagram illustrating an example of an access list possessed by a relay apparatus.

### DESCRIPTION OF THE EMBODIMENTS

A preferred embodiment of the present invention will now be described in detail with reference to the drawings. It should be noted that the following embodiment is merely illustrative and does not limit the scope of the present invention.

### First Embodiment

A first embodiment of an information processing apparatus according to the present invention will be described below taking as an example a relay apparatus 101 for selecting any of three server apparatuses (regional servers 104 to 106) based upon a content request from an image processing apparatus 103, which is a client apparatus.

<System Configuration>

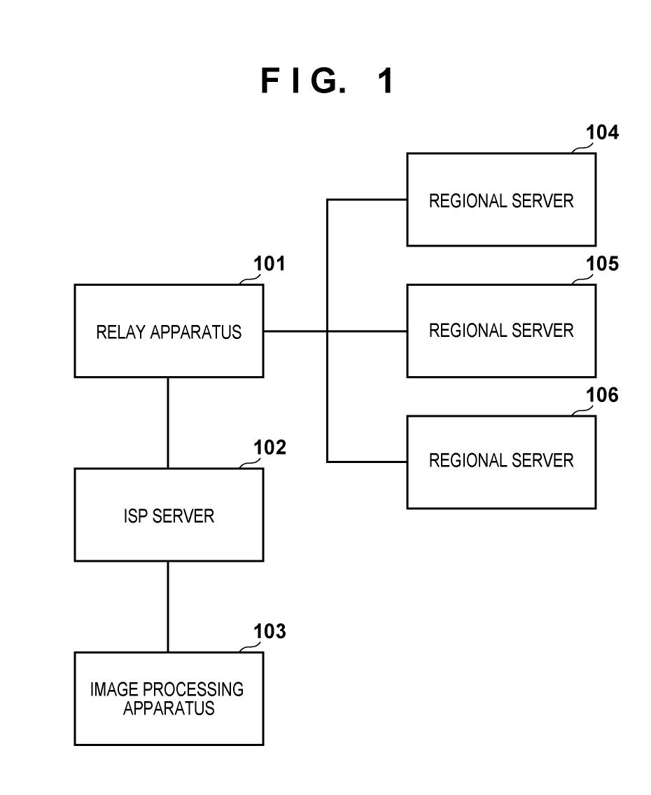

FIG. 1 is an overall block diagram of a content distribution system according to the first embodiment. The image processing apparatus 103, which is a client apparatus having a function for connecting to a network such as the Internet, acquired content from the servers. An MFP (Multi-Function Peripheral) is an example of the image processing apparatus 103. An ISP server 102, which is a network device provided by an Internet Service Provider (ISP), accepts connection of a client apparatus belonging to a user who has entered into an agreement with the ISP. Further, the ISP server 102 has a function for assigning a global IP address to the client apparatus of the user.

The relay apparatus 101 receives a content acquisition request (an HTTP request, for example) from the image processing apparatus 103 and transfers this content acquisition request to the regional server suited to the image processing apparatus 103. The details of this transfer processing will be described later.

The regional servers 104 to 106, which store content, respond to the content acquisition request transferred from the relay apparatus 101 by providing the corresponding content to the client apparatus (image processing apparatus 103, etc.) that issued the content acquisition request. Further, the regional servers 104 to 106 are arranged so as to operate in association with the service of the image processing apparatus. Here the regional servers 104 to 106 are arranged so as to provide content (service) to client apparatuses present in specific regions that differ from one another. It should be noted that an arrangement may be adopted in which the regional servers 104 to 106 are deployed at geographically different locations or at the same location.

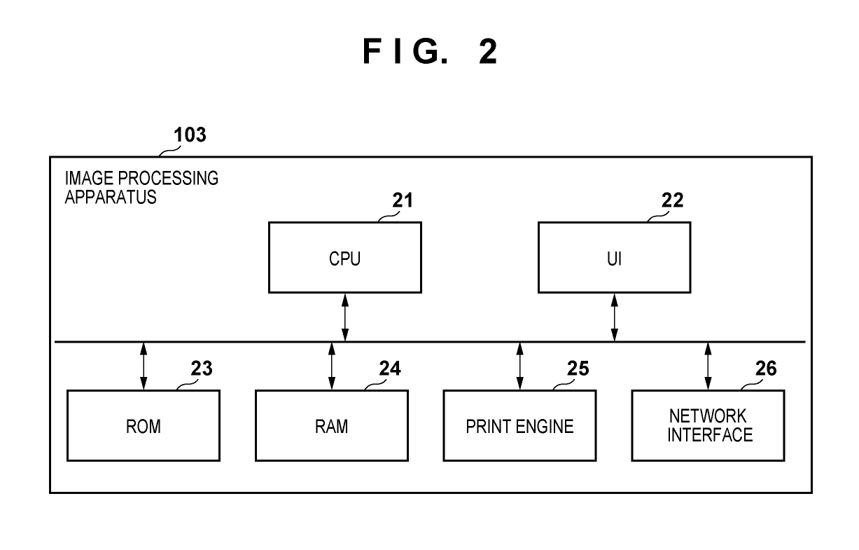

FIG. 2 is a block diagram of the interior of the image processing apparatus 103. The image processing apparatus 103 includes a CPU 21, a ROM 23, a RAM 24 a user interface (UI) 22, a print engine 25 and a network interface (I/F) 26.

The CPU 21 controls the overall operation of the image processing apparatus 103. More specifically, the CPU 21 performs various operations by reading out and executing an operating system and program that have been stored in the ROM 23. The RAM 24, besides being used as a work area when the CPU 21 executes the operating system or program, also serves as a temporary storage device in which various information (image data and the like) is expanded. The print engine 25 is a functional unit which, for example, prints image data received from a server via the Internet on a printing medium. The network interface 26 is an interface via which the image processing apparatus 103 communicates with various external devices over a network. For example, IP packets are sent and received by utilizing Ethernet (registered trademark) or a wireless LAN interface. It should be noted that the ROM 23 also stores country/region information (an area identifier) that corresponds to the image processing apparatus 103. The country/region information is information indicating the country or region to which the image processing apparatus 103 is delivered. The region in which the user of the image processing apparatus 103 purchased the image processing apparatus 103, for example, is specified by the country/region information. In the description that follows, the country/region information will be described as whichever of “region A”, “region B” or “Region C” has been stored in RAM 23. It may be arranged so that the country/region information is stored on a hard-disk drive (HDD) or in a non-volatile storage device such as a flash memory.

The user interface 22 is used to operate the image processing apparatus 103, to input information and to allow the image processing apparatus 103 to display information to the user. For example, the user interface 22 is constituted by a liquid crystal display screen (LCD) and a touch-sensitive panel in addition to hardware switches and buttons.

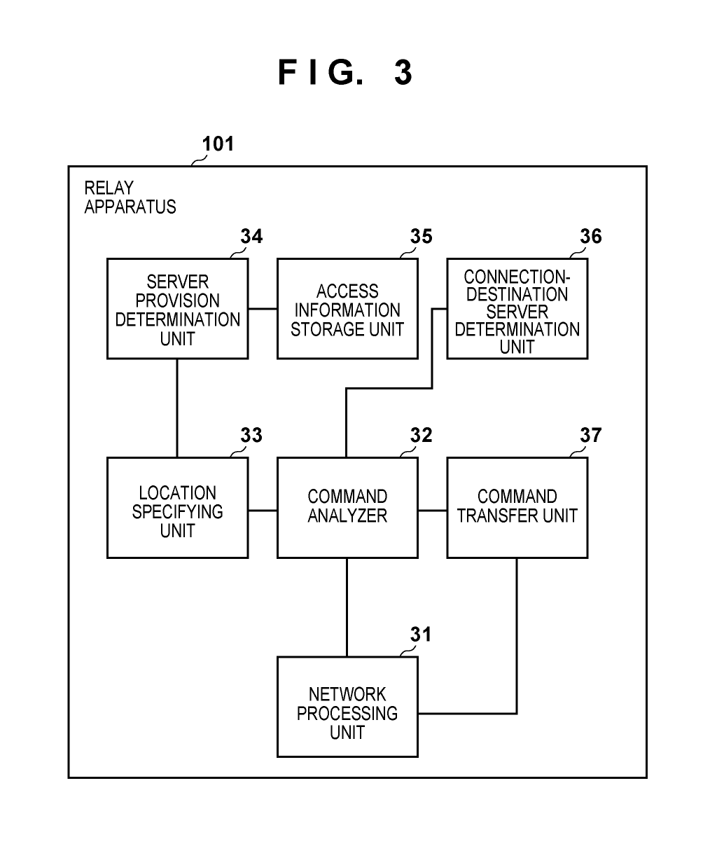

FIG. 3 is a functional block diagram of the relay apparatus 101. The relay apparatus 101 is a network apparatus that operates as a proxy server apparatus or gateway server apparatus of a regional server with respect to the image processing apparatus 103. In other words, when content that has been stored in the regional servers 104 to 106 is acquired, the client apparatus such as the image processing apparatus 103 accesses the relay apparatus 101.

The relay apparatus 101 has a network processing unit 31 for sending and receiving IP packets via the network. A command analyzer 32 analyzes IP packets received by the network processing unit 31. When command analysis is performed, a determination as to whether an analyzed command is to be processed or not is made by a location specifying unit 33 and a connection-destination server determination unit 36. A server list that correlates each of the regional servers 104 to 106 to certain ones of a plurality of regions has been stored in the connection-destination server determination unit 36. Further, each of the plurality of regions corresponds to country/region information mentioned above.

The relay apparatus 101 has a server provision determination unit 34 and, by referring to an access list that has been stored in an access information storage unit 35, determines whether it is the target of service provision. It should be noted that the access list can have a provision list format that clearly indicates a zone within which service provision is permitted, a non-provision list format that clearly indicates a zone within which service is not provided, or some other list format. In any case, the access list defines, in correlation with a network identifier, whether content is allowed to be accessed. A command transfer unit 37 transfers a communication to the effect that the server provision determination unit 34 has determined that service provision is permitted. More specifically, the command transfer unit 37 transfers a content acquisition request (an HTTP request message, for example) from the client apparatus to the prescribed server apparatus (regional server). Further, the command transfer unit 37 transfers content (an HTTP response message, for example), which is transmitted from the server apparatus, to the prescribed client apparatus. The operation of the relay apparatus 101 will be described in detail below.

<Operation of Relay Apparatus>

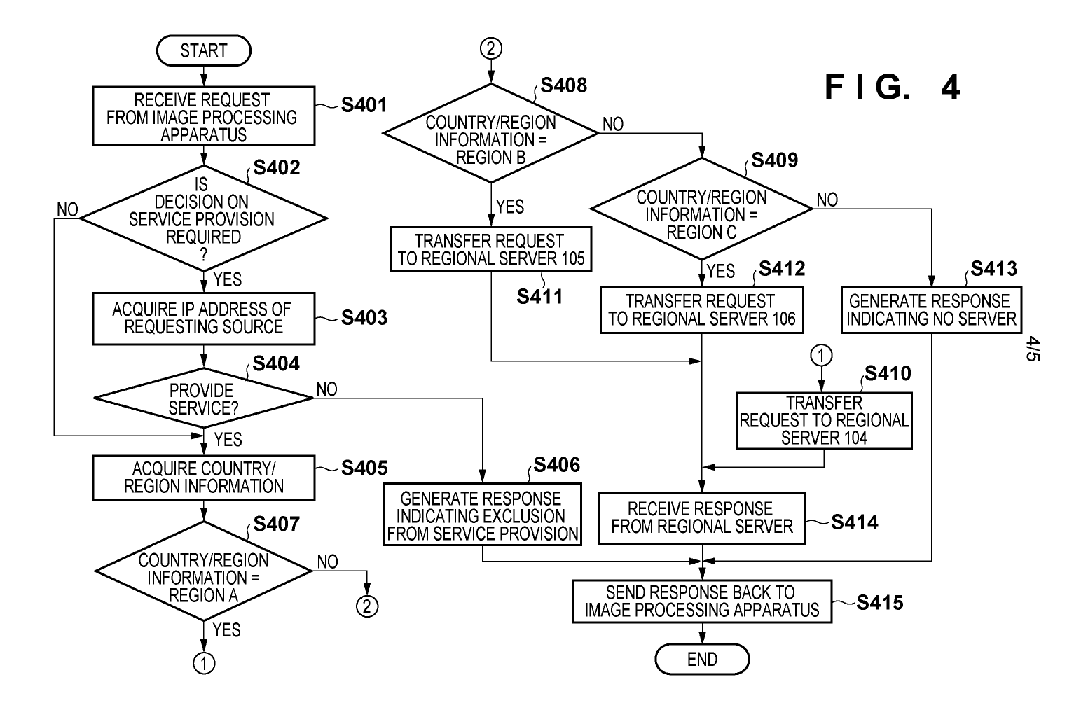

FIG. 4 is an operation flowchart of processing executed by the relay apparatus. It should be noted that the processing below is started as a result of the user of the image processing apparatus 103 operating the user interface 22 and the image processing apparatus 103 transmitting a content acquisition request (an access request such as an HTTP request) to the relay apparatus 101 via the network interface 26. The content acquisition request includes the IP address that has been assigned to the image processing apparatus 103 and the above-mentioned country/region information.

At step S401, the relay apparatus 101 receives a content acquisition request from the image processing apparatus 103. Then, at step S402, the relay apparatus 101 determines whether the received content acquisition request is one requiring a decision as to whether service is to be provided. Control proceeds to step S403 if it is determined that a decision as to whether to provide service is required or to step S405 if it is determined that this decision is not required. The determination as to whether a decision is required or not is made, for example, based upon the content that is the object of the acquisition request.

At step S403, the relay apparatus 101 extracts from the received content acquisition request the network identifier (IP address) of the source (namely the image processing apparatus 103) of the request. Then, at step S404, the relay apparatus 101 uses the location specifying unit 33 to specify the location to which the IP address extracted at step S403 corresponds. The relay apparatus 101 then determines whether or not to provide the content (service) to this region. In other words, the relay apparatus 101 determines whether to allow the image processing apparatus 103 access to this content. Whether or not service is provided is determined by referring to the above-mentioned access list.

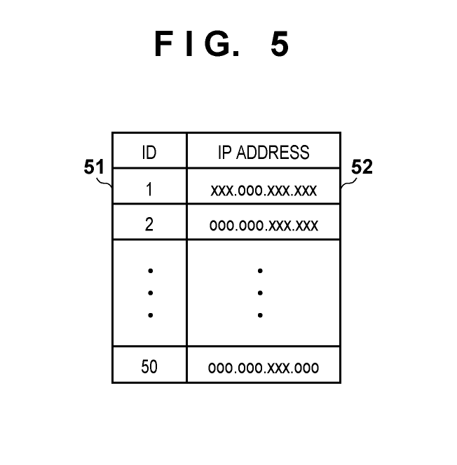

FIG. 5 is a diagram illustrating an example of an access list. In the example of FIG. 5, the access list is illustrated as one including one or more pairs of an index number (ID) 51 and IP address 52. It should be noted that although specific single IP addresses are indicated as IP addresses in FIG. 5, the access list may be created so as to indicate specific ranges of IP addresses.

Further, although an access list using IP addresses as the reference is described here, an arrangement may be adopted in which use is made of an access list that employs another reference such as domain name. In such case, an arrangement may be adopted in which the relay apparatus 101 subjects a domain name system (DNS) (not shown) to reverse DNS lookup access to thereby acquire the domain name that corresponds to the IP address of the image processing apparatus 103.

If it is determined at step S404 that service will not be provided, control proceeds to step S406. If it is determined that service will be provided, then control proceeds to step S405.

At step S405, the relay apparatus 101 extracts country/region information included in the received content acquisition request. Then, at steps S407 to S409, the connection-destination server determination unit 36 determines the region (“region A”, “region B” or “region C”, for example) indicated by the country/region information. It should be noted that only three regions are shown in order to simplify the description, though regions may be classified into any number of regions. At steps S410 to S412, the relay apparatus 101 decides the regional server corresponding to the determined region based upon the already stored server list and transfers the content acquisition request to the regional server decided. The relay apparatus 101 transfers the content acquisition request to the regional server 104 if “region A” has been determined, to the regional server 105 if “region B” has been determined, and to the regional server 106 if “region C” has been determined. The regional server that has received the content acquisition request sends a response to this content acquisition request back to the relay apparatus 101.

At step S414, the relay apparatus 101 receives the response from the regional server. At step S406, on the other hand, the relay apparatus 101 generates a response indicating exclusion from service provision. Further, at step S413, the relay apparatus 101 generates a response indicating that a server apparatus capable of service provision does not exist (i.e., generates an “error” response). Then, at step S415, the relay apparatus 101 transmits the received or generated response to the image processing apparatus 103.

In the description rendered above, it is described that the selection of the server apparatus (steps S407 to S412) is performed automatically in a case where it is determined that service provision is permitted, namely in a case where it is determined that it is possible for the image processing apparatus 103 to access the content. However, it may be so arranged that at the moment the relay apparatus 101 determines that service provision is permitted, the relay apparatus 101 notifies the image processing apparatus 103 to the effect that service provision has been permitted (to the effect that the content is accessible). In this case, the image processing apparatus 103 should be arranged so that it will accept a further indication from the user (such as an indication as to whether the content is truly to be received) via the user interface 22.

In accordance with the first embodiment as described above, the relay apparatus is capable of determining, based upon an access list, whether processing of a content acquisition request from a client apparatus is to be executed or not, and of controlling access to this content.

Further, by extracting region information (country/region information) included in a content acquisition request, the relay apparatus is capable of readily deciding the server apparatus that corresponds to the particular region. As a result, even in a case where, for example, the user purchases an image processing apparatus in his own country and uses this apparatus in a foreign country, the fact that the user's own country is specified by the country/region information means that the server corresponding to the user's own country can be accessed. This enables the user to readily acquire content written in the language of the user's own country, by way of example.

It should be noted that although an example has been described in which country/region information is adopted as a condition with regard to changing over the server at the access destination, various other conditions may be used instead of or in addition to country/region information. The language to which the image processing apparatus has been set, for example, is used as the condition. By changing over the access destination based upon the language setting, content conforming to the language used by the user can be provided.

Further, information as to the location of a presence of the client apparatus that accesses content can be acquired by using the IP address. Access to the server can be controlled appropriately by this location information. Further, since the server accessed by the client apparatus is specified in accordance with country/region information in the above-described embodiment, access is allowed to the server conforming to the country/region of this client apparatus.

In the description rendered above, whether a client apparatus is allowed to access a server is determined by the IP address of the client apparatus and then the server to be accessed is selected in accordance with the country/region information. However, this does not impose a limitation; access may be controlled upon combining an IP address and country/region information. Specifically, whether a server is allowed to be accessed or not and, in addition, the particular server at the access destination in a case where access is allowed, may be determined in accordance with a combination of an IP address and country/region information.

Further, in the description rendered above, an example is illustrated in which each of a plurality of regional servers provides content. However, an arrangement may be adopted in which a single server provides content conforming to a plurality of regions. In this case, an arrangement may be adopted in which a plurality of access destinations (URLs or the like) corresponding to a plurality of regions are set in the single server and content for the region conforming to the particular access destination is provided.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-161370, filed Jul. 22, 2011, which is hereby incorporated by reference herein in its entirety.

What is claimed is:

1. An information processing apparatus for controlling access by a client apparatus, comprising:
a receiving unit configured to receive an access request, which is a request by the client apparatus to access content, from the client apparatus together with an area identifier for specifying an area that corresponds to the client apparatus;
a decision unit configured to specify location of the client apparatus based upon the access request received from said receiving unit and to decide in accordance with the specified location whether the client apparatus is allowed to access the content; and
a determination unit configured to specify the area corresponding to the client apparatus, based upon the area identifier received by said receiving unit, and to determine an access destination to which the client apparatus accesses based upon the access request in a case where said decision unit decides to allow access by the client apparatus to the content, in accordance with the specified area.

2. The apparatus according to claim 1, further comprising a transfer unit configured to transfer a packet received from the client apparatus to the access destination determined by said determination unit, and to transfer a packet, which has been received from the access destination in accordance with the transfer, to the client apparatus.

3. The apparatus according to claim 1, further comprising a notification unit configured to notify the client apparatus of the fact that access to the content is allowed when said decision unit has decided to allow access to the content.

4. The apparatus according to claim 1, wherein said decision unit acquires an IP address of the client apparatus based upon the access request by the client apparatus, and specifies the location of the client apparatus based upon the acquired IP address.

5. An information processing method of controlling access by a client apparatus, comprising:
receiving an access request, which is a request by the client apparatus to access content, from the client apparatus together with an area identifier for specifying an area that corresponds to the client apparatus;
specifying location of the client apparatus based upon the received access request and deciding in accordance with the specified location whether the client apparatus is allowed to access the content; and
specifying the area corresponding to the client apparatus, based upon the received area identifier, and determining an access destination to which the client apparatus accesses based upon the access request in a case where it is decided to allow access by the client apparatus to the content, in accordance with the specified area.

6. A non-transitory computer-readable storage medium storing a computer program for causing a computer to execute the information processing method set forth in claim 5.
